(19) United States
(12) Patent Application Publication
(10) Pub. No.: US 2010/0118136 A1
(43) Pub. Date: May 13, 2010

(54) SURFACE INSPECTION DEVICE AND AN ARRANGEMENT FOR INSPECTING A SURFACE

(76) Inventors: Jan Arie Pieter van Riet, Hyssna (SE); Jonas Hallbäck, Goteborg (SE)

Correspondence Address: SKF USA Inc., 890 Forty Foot Road, PO Box 332, Kulpsville, PA, 19443, US

(21) Appl. No.: 12/452,065

(22) PCT Filed: Jun. 13, 2007
(86) PCT No.: PCT/SE2007/000583

§ 371 Date: Dec. 14, 2009

(51) Int. Cl. H04N 7/18; G06K 9/00

(52) U.S. Cl. 348/92; 382/152; 348/E07.085

(57) ABSTRACT

The invention concerns a device for inspecting a surface of a workpiece (1) comprising a processor for reading image data of the surface, wherein the image data comprises at least a bright field (B) and at least a dark field (D1). A portion (A) of the surface is in the image data in at least one position in the bright field. (B) and in at least a second position in the dark field (D1). The processor generates a result by comparing the portion (A) in the bright field (B) to the portion (A) in the dark field (D1) in order to find surface anomalies, and outputs the result using an outputting means. Furthermore, the invention concerns a surface inspection arrangement for inspecting a workpiece (1) comprising the device, and further comprising a light source (2), at least one image pick-up device (3) and means for transferring the image data from the image pick-up device (3) to the processor that reads image data.

### FIELD OF THE INVENTION

According to a first aspect, the invention concerns a device for inspecting a surface of a workpiece.

According to a second aspect, the invention concerns a surface inspection arrangement for inspecting a surface of a workpiece.

### BACKGROUND

Optical inspection of surfaces is common to use in order to detect surface anomalies and defects of different kinds on workpieces. However, known methods, systems and devices for inspecting surfaces have shown to have problems, disadvantages and be limited to one or a few types of defects.

### SUMMARY OF INVENTION

An object of the invention is to provide an improved surface inspection device for detecting a larger number of surface defects on a workpiece and to increase the reliability of the inspection.

One method is to inspect surfaces by illuminating the surface and to position an optical detector in the bright field. In bright field illumination, a detector is positioned at the reflection angle of the light. Thus, if there are no defects on the surface, the light is reflected into the detector. However, if there is a defect on the surface, the angle of the reflected light from the defected surface will differ from the angle of the reflected light, were there no defects on the surface. Thus, the defect will be detected as a reduction in light intensity and may be spotted as a dark area.

Another method is to detect defects by illuminating the surface and positioning the optical detector in the dark field, i.e. the detector is not positioned at the reflection angle of the light. In this case, defects may be spotted as light areas.

The variation in light intensity of the dark field and the bright field may be described according to a light intensity curve. For instance, it may be described according to a Gaussian distribution, i.e. a normal distribution, in part or in whole.

According to a first aspect, the object is achieved by a device for inspecting a surface of a workpiece comprising a processor for reading image data of the surface, wherein the image data comprises at least a bright field and at least a dark field. A portion of the surface is in the image data in at least one position in the bright field and in at least a second position in the dark field. The processor generates a result by comparing the portion in the bright field to the portion in the dark field in order to find surface anomalies, and outputs the result using an outputting means.

By using a combination of dark and bright field illumination of the portion of the surface and compare the same portion in the dark and the bright field, it is possible to detect more types of surface anomalies. Also, the reliability of the inspection increases.

In an embodiment, the image data comprises at least two images of the portion, where one of the two images comprises a bright field and the second image comprises a dark field. The two images may also be a unitized image of the two images.

In an embodiment, the image data comprises at least two images of the portion, where one of the at least two images comprises a bright field and at least a dark field.

In an embodiment, the image data comprises a bright field, a first dark field and a second dark field.

In an embodiment, the portion of the surface is in the image data in at least one position in the first dark field, in at least one position in the bright field and in at least one position in the second dark field. When inspecting the portion of the surface in three fields, dark, bright and dark, it is possible to detect even more types of defects. Also, the reliability of the inspection will increase further because surface anomalies that are not symmetrical may appear in at least one of the three fields.

In an embodiment, the image data comprises at least three images.

In an embodiment, one of the at least three images comprises a dark field, a second image comprises a bright field and a third image comprises a dark field.

In an embodiment, one of the at least three images comprises a first dark field, a bright field and a second dark field.

In an embodiment, the outputting means is one of a storing means, a visualizing means, a data transmission means or an e-mail.

In an embodiment, the visualizing means is one of a monitor, a display or a print-out. For instance, it may be possible for an operator to manually inspect the result outputted from the processor. This may be done in a production environment, a lab or any other environment where surface inspection is performed.

In an embodiment, the storing means is any of a memory, a hard drive, a database or a file. It may be good to store the data for many different purposes, such as further image processing, documentation and other later needs.

In an embodiment, the device is a computer.

In an embodiment, the device is incorporated into a camera.

In an embodiment, the device further comprises an analyzing means for analyzing the outputted result from the outputting means. The analyzing means may be a processor, software, a computer, an ASIC (Application Specific Integrated Circuit), an FPGA (Field Programmable Gate Array) etc.

In an embodiment, the analyzing means classifies a plurality of different surface anomalies. Some examples of surface anomalies that may be classified are nicks, dents, bumps, corrosion, cracks, imprints, scratches, emulsion marks or liquid.

In an embodiment, the surface of the workpiece is any of a convex surface or a concave surface. Furthermore, it may also be possible to inspect a flat surface if the surface roughness is low.

In an embodiment, the workpiece is any of a bearing, a bearing inner ring, a bearing outer ring, a bearing rolling element, a shaft, an axle, a pipe, a ring, a ball, a roller, a cylindrical shaped element, a barrel shaped element or any other rotation body. The shape of the surface of the inspected workpiece affects the light distribution of the reflected light from the workpiece, i.e. the appearance of the image data.

According to the second aspect of the invention, the object is achieved by a surface inspection arrangement for inspecting a workpiece comprising the device according to the first aspect, and further comprising a light source for illuminating at least a section of a surface of a workpiece. Furthermore, the arrangement comprises at least one image pick-up device for creating image data of the surface of the workpiece and means for transferring the image data from the at least one image pick-up device to the processor that reads image data. All features and embodiments of the first aspect of the invention are applicable to all features and embodiments of the second aspect of the invention and vice versa.

By using a combination of dark and bright field illumination of the portion of the surface and compare the same portion in the dark and the bright field, it is possible to detect more types of surface anomalies. Also, the reliability of the inspection increases.

In an embodiment, the arrangement comprises means for accomplishing a relative movement between the at least one image pick-up device and the workpiece. It may either be the workpiece, the image pick-up device or both that may be moving. Examples of such means may be a rotating table, a turntable or a chuck, on which the workpiece or the image pick-up device is placed or fixed to.

In an embodiment, image data is picked up by the image pick-up device either at one time, continuously or intermittently. If the image data is picked up continuously, new image data is constantly captured and transmitted to the processor. This assures that image data of all the portions of the surface of the workpiece is created and inspected. If the image data is picked up regularly or intermittently, new image data is captured and transmitted to the processor at certain regular, irregular or random occasions. An advantage is that a reduced amount of storage is needed, or that a reduced amount of transmitted data is needed.

In an embodiment of the arrangement, at least one of the image pick-up devices creating image data picks up an image comprising a first dark field, a bright field, and a second dark field.

When image data is picked up, its light intensity may be described according to a light intensity curve, which may be shifted due to eccentricity, waviness or imperfect centring of the workpiece. It may be needed to compensate for this shifting before the comparing of the portion in the first dark, bright and second dark field is performed. The compensation may be performed by selecting and tracking at least one specific point on the light intensity curve. By this, the outputted data from the processor may be improved since it is ascertained that a deviation in light intensity from the light intensity curve corresponds to a defect of the surface and not to eccentricity etc. Consequently, more types of defects may be detected and the reliability of the inspection may be improved. This is also applicable when the processor compares one dark and one bright field. The compensation may be performed by the same processor as above, but also by another processor.

It is also possible to measure eccentricity or waviness of the workpiece by analyzing shape and deviations of the light intensity curve.

In an embodiment, the arrangement has at least two image pick-up devices creating image data. At least one of the at least two image pick-up devices picks up an image of the portion in the bright field and at least one of the image pick-up devices picks up an image of the portion in the dark field.

In an embodiment, the arrangement has at least three image pick-up devices creating image data. At least one of the image pick-up devices picks up an image of the portion in the first dark field, at least one of the image pick-up devices picks up an image in the bright field and at least one of the image pick-up devices picks up an image of the portion in the second dark field.

In an embodiment of the arrangement when having at least two image pick-up devices, the at least two images are created essentially simultaneously.

In an embodiment of the arrangement, the transferring means is any of an electric cable, an optical cable, a wireless transmitter, a data network, the Internet or a modem. Thus, the image pick-up device and the processor may be remotely located.

In an embodiment of the arrangement, the image pick-up device is any of a matrix camera, a plurality of line cameras or a scanner. A plurality of line cameras may have a similar image pick-up area as a matrix camera. It is possible to use all the available lines of the matrix camera, the plurality of line cameras or the scanner, as well as only a limited number of lines. The preferred number of lines may depend on the dimensions of the workpiece, the illumination, the image pick-up device, the processor etc.

The image pick-up device may also be an arrangement comprising a lens and an optical sensor, or a lens and a light sensor, or a lens and any other suitable sensor.

The invention may be advantageous to use in a manufacturing line, assembly line etc. for automatic rejection of a workpiece that does not meet the specifications. This leads to an increased productivity and higher quality of the final workpieces.

In a third aspect of the invention, the object is achieved by a method for inspecting a surface of a workpiece, comprising, reading image data of the surface, wherein the image data comprises at least a bright field and at least a dark field. A portion of the surface is in the image data in at least one position in the bright field and in at least a second position in the dark field. A result is generated by comparing the portion in the bright field to the portion in the dark field in order to find surface anomalies, and the result is outputted. All features and embodiments of the first and second aspect of the invention are applicable to all features and embodiments of the third aspect of the invention and vice versa.

### BRIEF DESCRIPTION OF DRAWINGS

FIG. 1a: Image data of a portion of a surface according to the invention.

FIG. 1b: Two image pick-up devices creating image data of a portion of a surface according to the invention.

FIG. 2a: Image data of a portion of a surface according to the invention.

FIG. 2b: Three image pick-up devices creating image data of a portion of a surface according to the invention.

FIG. 3a: Image data following a portion of a surface according to the invention.

FIG. 3b: An image pick-up device creating image data of a portion of a surface according to the invention.

FIG. 4a: Image data following a portion of a surface according to the invention.

FIG. 4b: An image pick-up device creating image data of a portion of a surface according to the invention.

FIG. 5: Image data of a plurality of portions of a surface according to the invention.

FIG. 6a: A schematic illustration showing how a surface anomaly may appear in a dark field and a bright field of image data according to the invention.

FIG. 6b: A schematic illustration showing how a surface anomaly may appear in a first dark field, a bright field and a second dark field of image data according to the invention.

FIG. 7a: A light intensity curve of a first dark field, a bright field and a second dark field of image data according to the invention.

FIG. 7b: A light intensity curve in three dimensions of a first dark field, a bright field and a second dark field of image data according to the invention.

FIG. 7c: A light intensity curve in three dimensions of a first dark field, a bright field and a second dark field of image data according to the invention.

FIG. 8: A surface inspection arrangement for inspecting a workpiece according to the invention.

FIG. 9: A flowchart of a processor reading image data according to the invention.

### DETAILED DESCRIPTION OF THE DRAWINGS

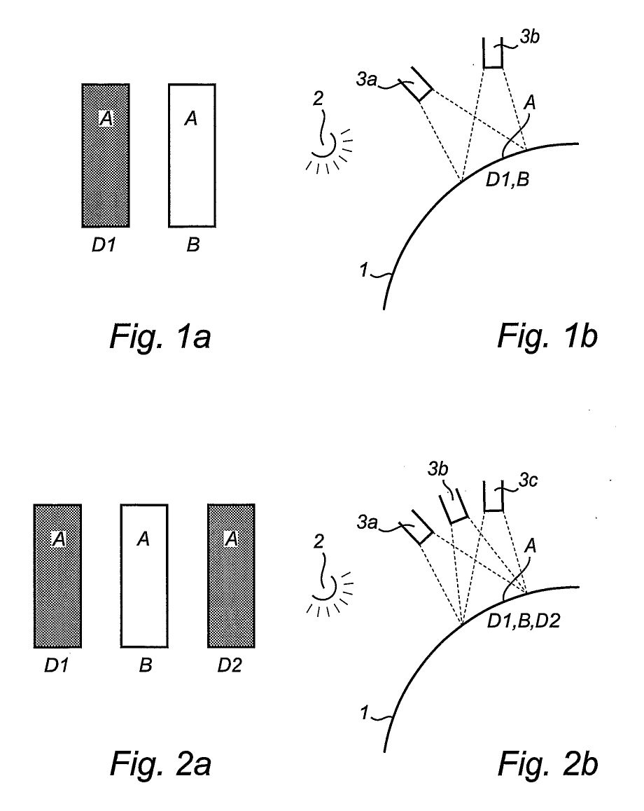

In FIG. 1a, image data of a portion of a surface according to the invention is illustrated. It shows image data of a portion A of a surface of a workpiece 1. The portion A is in at least one position in a bright field B and in at least a second position in a dark field D1. The portion A may be in the whole area covered by the image data of the dark field, but may also be only in a fragment of the dark field. This also applies to the portion A, when in the bright field.

In FIG. 1b, two image pick-up devices creating image data of a portion A of a surface according to the invention are illustrated. It shows a cross-section of a workpiece 1 that is to be inspected. A light source 2 is arranged to illuminate at least a section of the workpiece 1. Two image pick-up devices 3a, 3b create image data of the portion A of the surface. The two image pick-up devices are so arranged that one of the image pick-up devices 3b creates an image of a bright field B, and that one of the image pick-up devices 3a creates an image of a dark field D1. The pick-up areas of the two image pick-up devices may be adjacent or overlapping each other. In this embodiment, the surface of the workpiece is convex, but it may also be concave or in any other shape. The image data created by the two image pick-up devices in this embodiment may result in the image data as shown in FIG. 1a. A defect may be spotted as a bright spot in the dark field or as a dark spot in the bright field. A defect may also be spotted in both the dark field and in the bright field.

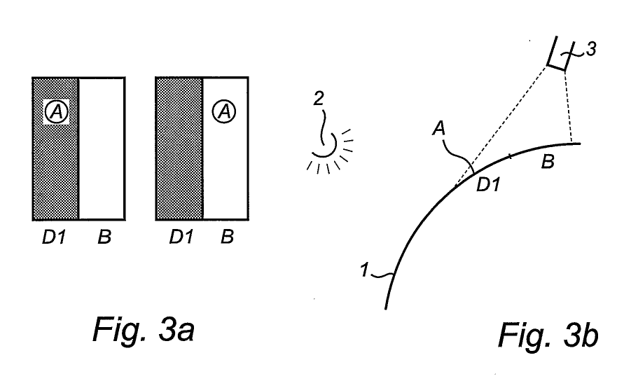

In FIG. 2a, image data of a portion of a surface according to the invention is illustrated. The figure shows image data of a portion A of a surface of a workpiece. The portion A is in at least one position in a first dark field D1, in at least one position in a bright field B and in at least one position in a second dark field D2. The portion A may be in the whole area covered by the image data of the dark field, but may also be only in a fragment of the dark field. This also applies to the portion A, when in the bright field B and the second dark field D2. In this embodiment, the image data comprises at least three images.

In FIG. 2b, three image pick-up devices creating image data of a portion A of a surface according to the invention are illustrated. It shows a cross-section of a workpiece 1 that is to be inspected. A light source 2 is arranged to illuminate at least a section of the workpiece 1. Three image pick-up devices 3a, 3b and 3c create image data of the portion A of the surface. The three image pick-up devices are so arranged that a first image pick-up device 3a creates an image of a first dark field D1, a second image pick-up device 3b creates an image of a bright field B, and a third image pick-up device 3c creates an image of a second dark field D1. The pick-up areas of the three image pick-up devices may be adjacent or overlapping each other. By this configuration, it may be possible to find even more types of defects and increase the inspection reliability. The reason why it is possible to find more types of defects, when having three image pick-up devices instead of two, is that this embodiment allows one additional angular setup to the illumination source. For instance, some defects, when illuminated, may result in a reflected light into image pick-up device 3c, and not 3a and vice versa. Furthermore, some defects, when illuminated, may result in a reflected light into both image pick-up device 3a and 3c. Consequently, there are several combinations possible. In this embodiment, the surface of the workpiece is convex, but it may also be concave or in any other shape. The image data created by the three image pick-up devices in this embodiment may result in the image data as shown in FIG. 2a.

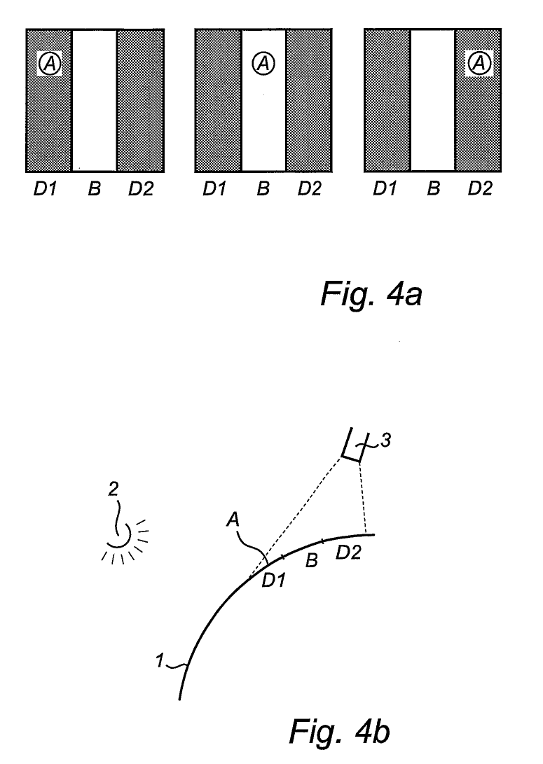

In FIG. 3a, image data presenting a portion A of a surface according to the invention is illustrated. In a first image, comprising a dark field D1 and a bright field B, the portion A is in the dark field D1. In a second image, comprising a dark field D1 and a bright field B, the portion A is in the bright field B. In this embodiment, the image data comprises two images, where each image comprises a dark field D1 and a bright field B.

In FIG. 3b, one image pick-up device 3 creating image data of a section of a workpiece 1 according to the invention is illustrated. It shows a cross-section of a workpiece 1 that is to be inspected. A light source 2 is arranged to illuminate at least a section of the workpiece 1. The image pick-up device 3 creates image data of a portion A. The image pick-up device is arranged to pick up a dark field D1 and a bright field B. In this embodiment, the surface of the workpiece 1 is convex, but it may also be concave or in any other shape. The image data created by the image pick-up device 3 in this embodiment may result in the image data as shown in FIG. 3a. In order to present the portion A in the dark field D1 and the bright field B, a relative movement between the workpiece 1 and the image pick-up device 3 is required. For instance, it may be the image pick-up device 3 that moves while the workpiece 1 is non-moving or the opposite. Also, both the workpiece 1 and the image pick-up device 3 may be moving, but having an additional movement in relation to each other.

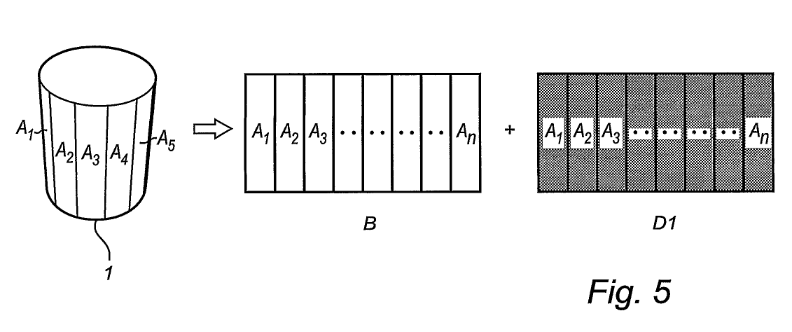

In FIG. 4a, image data presenting a portion A of a surface according to the invention is illustrated. In a first image, comprising a first dark field D1, a bright field B and a second dark field D2, the portion A is in the dark field D1. In a second image, comprising a first dark field D1, a bright field B and a second dark field D2, the portion A is in the bright field B. In a third image, comprising a first dark field D1, a bright field B and a second dark field D2, the portion A is in the second dark field D2. In this embodiment, the image data comprises three images, where each image comprises a first dark field D1, a bright field B and a second dark field D2.

In FIG. 4b, one image pick-up device 3 creating image data of a section of a workpiece 1 according to the invention is illustrated. It shows a cross-section of a workpiece 1 that is to be inspected. A light source 2 is arranged to illuminate at least a section of the workpiece 1. The image pick-up device 3 creates image data of a portion A. The image pick-up device is arranged to pick up a first dark field D1, a bright field B and a second dark field D2. In this embodiment, the surface of the workpiece 1 is convex, but it may also be concave or in any other shape. The image data created by the image pick-up device 3 in this embodiment may result in the image data as shown in FIG. 4a. In order to present the portion A in the first dark field D1, the bright field B and the second dark field D2, a relative movement between the workpiece 1 and the image pick-up device 3 is required. For instance, it may be the image pick-up device 3 that moves while the workpiece 1 is non-moving or the opposite. Also, both the workpiece 1 and the image pick-up device 3 may be moving, but having an additional movement in relation to each other. With an image pick-up device 3 picking up a first dark field D1, a bright field B and a second dark field D2, it may be possible to find even more types of defects and increase the inspection reliability. The reason why it is possible to find even more types of defects, when having such an image pick-up device 3, is that this embodiment allows one additional angular setup to the illumination source. For instance, some defects, when illuminated, may result in a reflected light into the second dark field D2, and not D1 and vice versa. Furthermore, some defects, when illuminated, may result in a reflected light into both the dark fields D1 and D2. Consequently, there are several combinations possible.

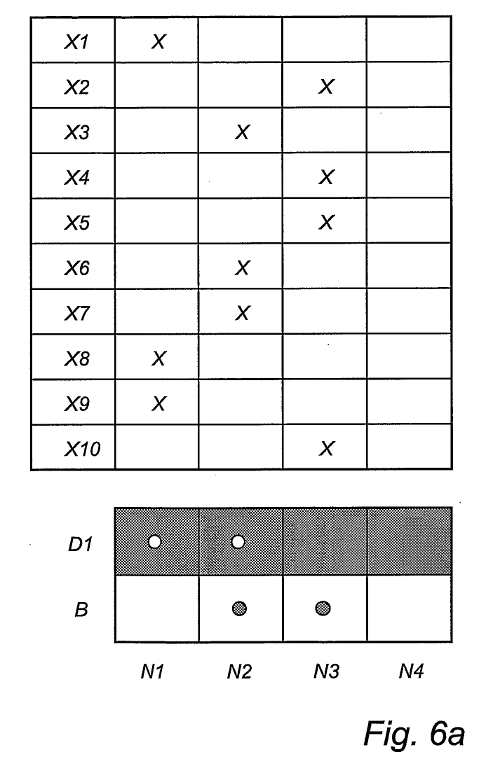

In FIG. 5, a rotation body 1, for instance a roller of a roller bearing, is inspected according to a preferred embodiment of the invention. It shows image data of a plurality of portions A1 to An of the peripheral surface of the rotation body 1 in a bright field B and in a dark field D1. The whole peripheral surface of the rotation body 1 is inspected by comparing each portion A1 to An of the surface in the bright field B and in the dark field D1. When image data of the rotation body 1 is created, it may be necessary to compensate for eccentricity, waviness etc.

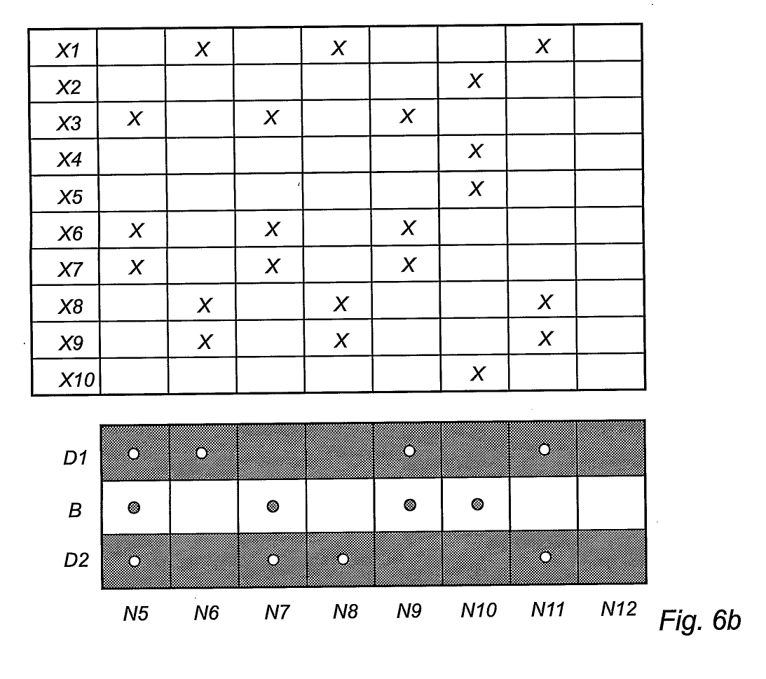

In FIG. 6a, a schematic illustration showing how a surface anomaly may appear in a dark field D1 and in a bright field B of image data according to the invention is illustrated. It shows how a surface anomaly in a portion A may appear in the dark field D1 and in the bright field B, as well as examples of possible corresponding types of surface anomalies. The different types of surface anomalies are shown in table 1.

TABLE 1

| | Type of defect |
|---|---|
| X1 | Dents |
| X2 | Smeared dirt |
| X3 | Dust |
| X4 | Corrosion |
| X5 | Unground area |
| X6 | Pits |
| X7 | Cracks |
| X8 | Scratches |
| X9 | Liquid |
| X10 | Emulsion marks |

In N1, the surface anomaly appears in the dark field D1 as a bright spot and do not appear in the bright field B. In N2, the surface anomaly appears in the dark field D1 as a bright spot and in the bright field B as a dark spot. In N3, the surface anomaly appears in the bright field B as a dark spot and do not appear in the dark field D1. In N4, no surface anomaly has been identified in the portion. Furthermore, shape, dimension and light intensity of the spots may vary in the dark field D1 and the bright field B. This information may be used for further analysis and classification of the surface anomalies.

In FIG. 6b, a schematic illustration showing how a surface anomaly may appear in a first dark field D1, a bright field B and a second dark field D2 of image data is illustrated. The different types of surface anomalies are also here shown in table 1. It follows the same principle as in FIG. 6a, but with an additional dark field D2. Now, even more types of surface anomalies may be detected because surface anomalies that are not symmetrical may appear in at least one of the three fields. For instance, in some cases a dent may be spotted in the first dark field D1 only, as shown in N6, whereas it in other cases may be spotted in the second dark field D2 only, as shown in N8. There may also be cases where a dent may be spotted in both the first dark field D1 and the second dark field D2, as shown in N11.

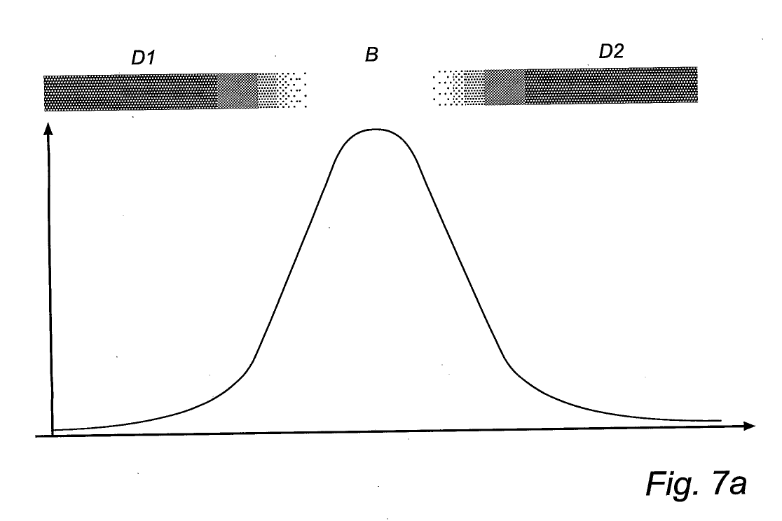

In FIG. 7a, a light intensity curve of a first dark field D1, a bright field B and a second dark field D2 of image data according to the invention is presented. It shows the distribution of the light intensity from the first dark field D1, to the bright field B and to the second dark field D2. A surface anomaly on an inspected surface of a workpiece may be detected in the light intensity curve as an increase in light intensity in the dark field D1 and in the dark field D2, and as a decrease in light intensity in the bright field B. Consequently, there are several combinations possible.

In FIG. 7b, a light intensity curve in three dimensions of a first dark field D1, a bright field B and a second dark field D2 of image data according to the invention is presented. It shows the distribution of the light intensity from the first dark field D1, to the bright field B and to the second dark field D2. In this embodiment, a surface anomaly is visualized by a decreased light intensity 4b in the bright field B.

In FIG. 7c, a light intensity curve in three dimensions of a first dark field D1, a bright field B and a second dark field D2 of image data according to the invention is presented. It shows the distribution of the light intensity from the first dark field D1, to the bright field B and to the second dark field D2. In this embodiment, a surface anomaly is visualized by an increased light intensity 4c in the first dark field D1.

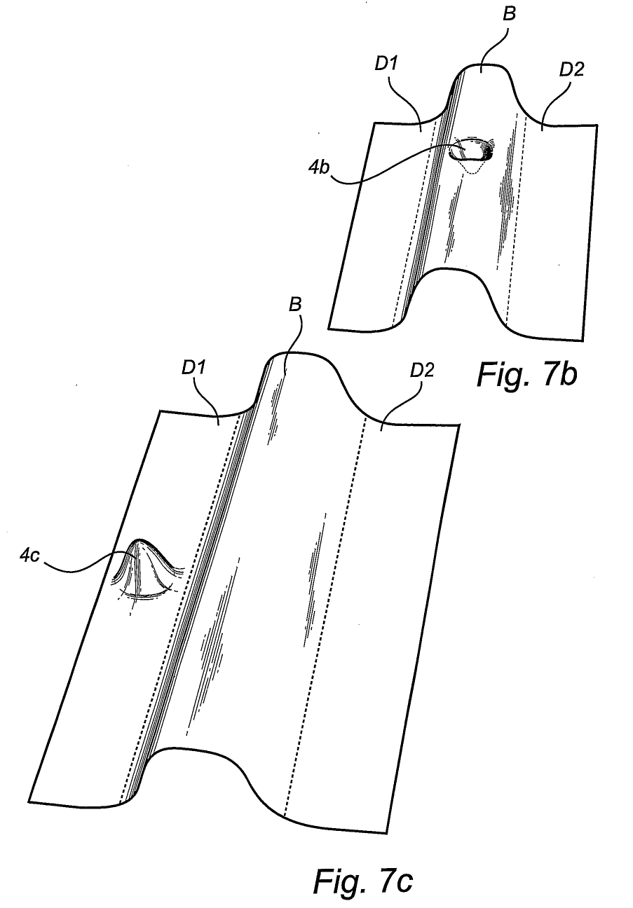

In FIG. 8, a surface inspection arrangement 5 for inspecting a workpiece 1 according to the invention is presented. The arrangement 5 comprises a light source 2 for illuminating at least a section of the workpiece 1. In this embodiment the workpiece 1 to be inspected is a bearing ring. Furthermore, the arrangement 5 comprises an image pick-up device 3 for creating image data of the surface of the workpiece 1. In this embodiment, the image data comprises a dark field D1 and a bright field B. Image data created by the image pick-up device 3 is transferred to a processor 6 by transferring means 7, which in this embodiment is an electric cable. The processor 6 reads the image data and generates a result by comparing a portion A of the surface in the dark field D1 and in the bright field B in order to find surface anomalies. A relative rotation of the workpiece 1 and the image pick-up device 3 is performed to be able to inspect the complete outer surface of the workpiece 1, which in this embodiment is the outer surface of the bearing ring. In this embodiment it is the workpiece that rotates on a turntable (not shown). The generated result is outputted by outputting means, which may be a monitor that visualizes the result.

Furthermore, in an embodiment the result may be analyzed by analyzing means, associated to the processor 6, where a plurality of different surface anomalies may be classified. The analyzing means may be incorporated with the processor 6. In an embodiment the analyzing means may be a computer software.

When the complete surface of the workpiece 1 has been inspected it may be possible to accept or reject the workpiece 1 according to a predetermined specification. The invention may be advantageous to use in a manufacturing line, assembly line etc. for automatic rejection of a workpiece that does not meet the specifications. This leads to an increased productivity and higher quality of the final workpieces.

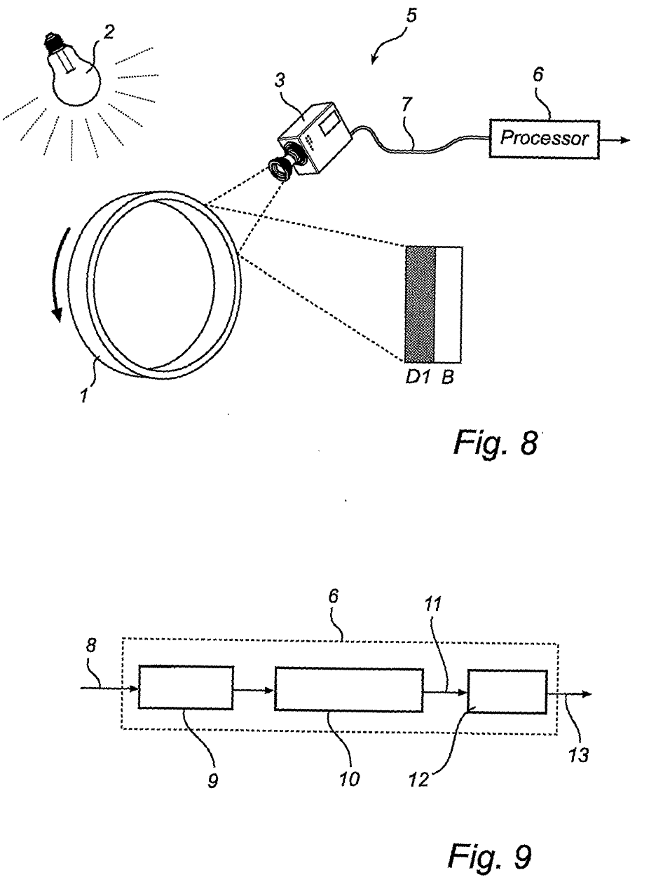

In FIG. 9, a flowchart of a processor 6 reading image data 8 according to the invention is illustrated. Image data 8 is put into the processor 6. In a first step 9, the processor 6 reads image data 8 of a surface, wherein the image data 8 comprises at least a dark field and a bright field. Subsequently, in a second step 10, the processor 6 compares a portion of the surface in the dark field and in the bright field. After the processor 6 has compared the portion, it forwards a generated result 11 to an outputting means 12, which creates an outputted result 13. It may be needed to compensate for eccentricity, waviness etc. This may be done before the step of comparing the portion in the dark field and the bright field. In a preferred embodiment, the processor 6 inspects the surface as in FIG. 5. Thus, a whole peripheral surface of a rotation body is inspected by comparing each portion of the surface in the bright field and in the dark field.

1. A device for inspecting a surface of a workpiece, the device comprising:
a processor configured to read image data of the surface, the image data including a bright field and a dark field, a portion of the surface being in the image data in at least a first position in the bright field and in at least a second position in the dark field, the processor being further configured to generate a result by comparing the portion in the bright field to the portion in the dark field in order to find surface anomalies and to output the result using an outputting means.

2. The device for inspecting a surface of a workpiece according to claim 1, wherein the image data includes at least two images.

3. The device for inspecting a surface of a workpiece according to claim 2, wherein one image includes a bright field and a second image includes a dark field.

4. The device for inspecting a surface of a workpiece according to claim 2, wherein one of the at least two images includes a bright field and at least one dark field.

5. The device for inspecting a surface of a workpiece according to claim 1, wherein the image data includes a bright field, a first dark field and a second dark field.

6. The device for inspecting a surface of a workpiece according to claim 5, wherein the portion of the surface is in the image data in at least one position in the first dark field, in at least one position in the bright field and in at least one position in the second dark field.

7. The device for inspecting a surface of a workpiece according to claim 5, wherein the image data includes at least three images.

8. The device for inspecting a surface of a workpiece according to claim 7, wherein one image includes a dark field, a second image includes a bright field and a third image includes a dark field.

9. The device for inspecting a surface of a workpiece according to claim 7, wherein one of the at least three images includes a first dark field, a bright field and a second dark field.

10. The device for inspecting a surface of a workpiece according to claim 1, wherein the outputting means is one of a storing means, a visualizing means, a data transmission means and an e-mail.

11. The device for inspecting a surface of a workpiece according to claim 10, wherein the visualizing means is one of a monitor, a display and a print-out.

12. The A device for inspecting a surface of a workpiece according to claim 10, wherein the storing means is any of a memory, a hard drive, a database and a file.

13. The device for inspecting a surface of a workpiece according to claim 1, wherein the processor is a computer.

14. The device for inspecting a surface of a workpiece according to claim 1, wherein the processor is incorporated into a camera.

15. The device for inspecting a surface of a workpiece according to claim 1, further comprising an analyzing means configured to analyze the outputted result from the outputting means.

16. The device for inspecting a surface of a workpiece according to claim 15, wherein the analyzing means is configured to classify a plurality of different surface anomalies.

17. The device for inspecting a surface of a workpiece according to claim 1, wherein the surface is one of a convex surface and a concave surface.

18. The device for inspecting a surface of a workpiece according to claim 1, wherein the workpiece is one of a bearing, a bearing inner ring, a bearing outer ring, a bearing rolling element, a shaft, an axle, a pipe, a ring, a ball, a roller, a cylindrical shaped element, a barrel shaped element and any other rotation member.

19. A surface inspection arrangement for inspecting a workpiece comprising,
a processor configured to read image data of the surface, the image data including a bright field and a dark field, a portion of the surface being in the image data in at least a first position in the bright field and in at least a second position in the dark field, the processor being further configured to generate a result by comparing the portion in the bright field to the portion in the dark field in order to find surface anomalies and to output the result using an outputting means,
a light source for illuminating at least a section of the surface of the workpiece,
at least one image pick-up device for creating image data of the surface of the workpiece, and
means for transferring the image data from the at least one image pick-up device to the processor.

20. The surface inspection arrangement for inspecting a workpiece according to claim 19, further comprising means for accomplishing a relative movement between the at least one image pick-up device and the workpiece.

21. The surface inspection arrangement for inspecting a workpiece according to claim 19, wherein the image data is picked up , one of one time, continuously and intermittently.

22. The surface inspection arrangement for inspecting a workpiece according to claim 19, wherein at least one of the image pick-up devices creating image data picks up an image including a first dark field, a bright field, and a second dark field.

23. The surface inspection arrangement for inspecting a workpiece according to claim 19, wherein the surface inspection arrangement includes at least two image pick-up devices creating image data, at least one of the image pick-up devices picks up an image of the portion in the bright field and at least one of the image pick-up devices picks up an image of the portion in the dark field.

24. The surface inspection arrangement for inspecting a workpiece according to claim 19, having at least three image pick-up devices creating image data, wherein at least one of the image pick-up devices picks up an image of the portion in the first dark field, at least one of the image pick-up devices picks up an image of the portion in the bright field and at least one of the image pick-up devices picks up an image of the portion in the second dark field.

25. The surface inspection arrangement for inspecting a workpiece according to claim 23, wherein the at least two images are created essentially simultaneously.

26. The surface inspection arrangement for inspecting a workpiece according to claim 19, wherein the transferring means is one of an electric cable, an optical cable, a wireless transmitter, a data network, the Internet and a modem.

27. The surface inspection arrangement for inspecting a workpiece according to claim 19, wherein the image pick-up device is one of a matrix camera, a plurality of line cameras and a scanner.
